(19) United States
(12) Patent Application Publication
(10) Pub. No.: US 2015/0031322 A1
(43) Pub. Date: Jan. 29, 2015

(54) MOBILE DEVICE FOR GROUP ACTIVITIES HAVING BROADCASTING OF EMERGENCY MESSAGES CAPABILITY

(71) Applicant: Cardo Systems Inc., Pittsburgh, PA (US)

(72) Inventors: Yossef Twina, Rosh Ha'ayin (IL); Abraham A. Moato, Rishon Lezion (IL)

(21) Appl. No.: 14/355,506

(22) PCT Filed: Oct. 29, 2012
(86) PCT No.: PCT/IL2012/050425

§ 371 Date: Apr. 30, 2014

(30) Foreign Application Priority Data
Oct. 31, 2011 (IL) 216073

(51) Int. Cl. H04W 4/22; H04W 76/02; H04W 4/06; H04W 4/00

(52) U.S. Cl. CPC H04W 4/22; H04W 4/008; H04W 76/02; H04W 4/06
USPC 455/404.1

(57) ABSTRACT

The invention relates to a mobile Bluetooth device mounted on a helmet of a user who engages in a group activity, the device comprises a Bluetooth manager for creating a Bluetooth voice communication channel between a source device and a target device via its BT transceiver, and further comprises an emergency generator for generating an emergency message, said emergency message is broadcasted to plurality of target devices via an alternative transceiver.

### FIELD OF THE INVENTION

The present invention relates in general to communication between mobile devices. More particularly, the invention relates to a mobile device having capability of broadcasting emergency messages to other of such devices, wherein said mobile devices are used in group activities, particularly by those who wear a helmet, such as motorcycle riders, bicycle riders, skiers, etc.

### BACKGROUND OF THE INVENTION

In many group activities the ability to communicate between two or more people engaging in them has become an important factor with the advent of radio communication. Illustrative examples of such group activities are motorcycle and bicycle riders, who engage in group tours and other activities, skiers, etc. Additionally, when motorcycles are involved, for instance, communication is important—and difficult.

Communications of this type have been rendered much more convenient and easy with the advent of Bluetooth technology, and a number of different Bluetooth headsets are available on the market, which permit communication between different people engaged in group activities. Bluetooth technology, has many advantages, however, the Bluetooth protocol is designed for the communication between two devices at each instance, while not allowing immediate broadcast of a message from a single device to several other devices.

As mentioned, driving of motorcycles in a group is a common habit. Groups of tens or even more of motorcycle riders that drive on public roads are quite frequently seen. The driving of a motorcycle may introduce dangerous situations, of which a motorcyclist may wish to inform other riders in the group, particularly those that follow him. The Bluetooth headsets that are presently available in the market are incapable of broadcasting immediate emergency messages from one device to plurality of other devices, particularly in view of the fact that the Bluetooth protocol is not designed for broadcasting of messages.

Another problem that exists in this case is the need to ensure that a transmitted emergency message arrives as many as possible riders, within a quite long range (of about 1-2 Km), while using device whose range of communication is limited to a shorter range.

Still another issue that has to be resolved is the need of the rider to issue such an emergency message in a most simple, immediate, and hands-free manner. There are Bluetooth communication devices for motorcyclists, however, as said, they are limited to Bluetooth communication, their operation is not a hands free operation, and they are incapable to broadcast emergency messages.

It is therefore highly desirable to provide a device which overcomes the above-mentioned disadvantages of the prior art. More specifically, it is an object of the present invention to provide a device for broadcasting emergency messages to plurality of other devices in the group.

It is a further object of the invention to provide such a device that enables broadcasting of such emergency messages to devices that are located at a range higher than the transmission range of the device which originates the message.

It is still another object of the invention to enable such transmission of said emergency message in a most compact, convenient, and safe manner to the user.

Other objects and advantages of the invention will become apparent as the description proceeds.

### SUMMARY OF THE INVENTION

The invention relates to a mobile Bluetooth device mounted on a helmet of a user who engages in a group activity, the device comprises a Bluetooth manager for creating a Bluetooth voice communication channel between a source device and a target device via its BT transceiver, and further comprises an emergency generator for generating an emergency message, said emergency message is broadcasted to plurality of target devices via an alternative transceiver.

Preferably, the device further comprise (a) a memory storage which stores target devices voice tags and an emergency voice tag; and (b) a voice command unit for receiving a user voice command from a microphone, and activating respectively either said a Bluetooth voice communication channel, or said broadcasting of the emergency message, depending on comparison between said voice command and said stored voice tags.

Preferably, said emergency generator is triggered to broadcast an emergency message by means of a push button.

Preferably, said generator generates and broadcasts a type 1 emergency message when said emergency message is first originated in the same device, and generates and broadcasts a type 2 emergency message upon receipt of a type 1 emergency message.

Preferably, the device further comprises headphones and a pre-recorded emergency message, and wherein upon receipt of an emergency message at a target device, said pre-recorded message is triggered, thereby sounding the message at said headphones.

Preferably, the device further comprises headphones and a pre-recorded emergency message, and wherein upon receipt of either a type 1 emergency message or a type 2 emergency message at a target device, whoever comes first, said pre-recorded message is triggered, thereby sounding the message at said headphones.

Preferably, upon receipt of a type 1 emergency message, said emergency generator generates and broadcasts a type 2 emergency message via its alternative transceiver.

Preferably, said user who engages in a group activity is a motorcyclist, a skier, or a bicycle rider.

Preferably, one or more of emergency messages are provided, while the user selects one message at a time for broadcasting.

### BRIEF DESCRIPTION OF THE DRAWINGS

In the drawings:

FIG. 1 illustrates in block diagram form the basic structure of a device for broadcasting an emergency message according to a first embodiment of the present invention; and

FIG. 2 illustrates in block diagram form the basic structure of a device for broadcasting an emergency message according to a second embodiment of the present invention.

### DETAILED DESCRIPTION OF PREFERRED EMBODIMENTS

As mentioned above, the invention provides a Bluetooth device having capability to broadcast emergency messages, for people who engage in group activities, such as motorcycle riders, bicycle riders, skiers, etc. Typically, in all said activities the user wears a protective helmet, and the device of the invention is typically designed to be attached to the user's helmet. The description below refers to a specific need of motorcyclists, but as said, the device of the invention is likewise suitable to be used by all those who engage in group activities, that require wearing of a protective helmet.

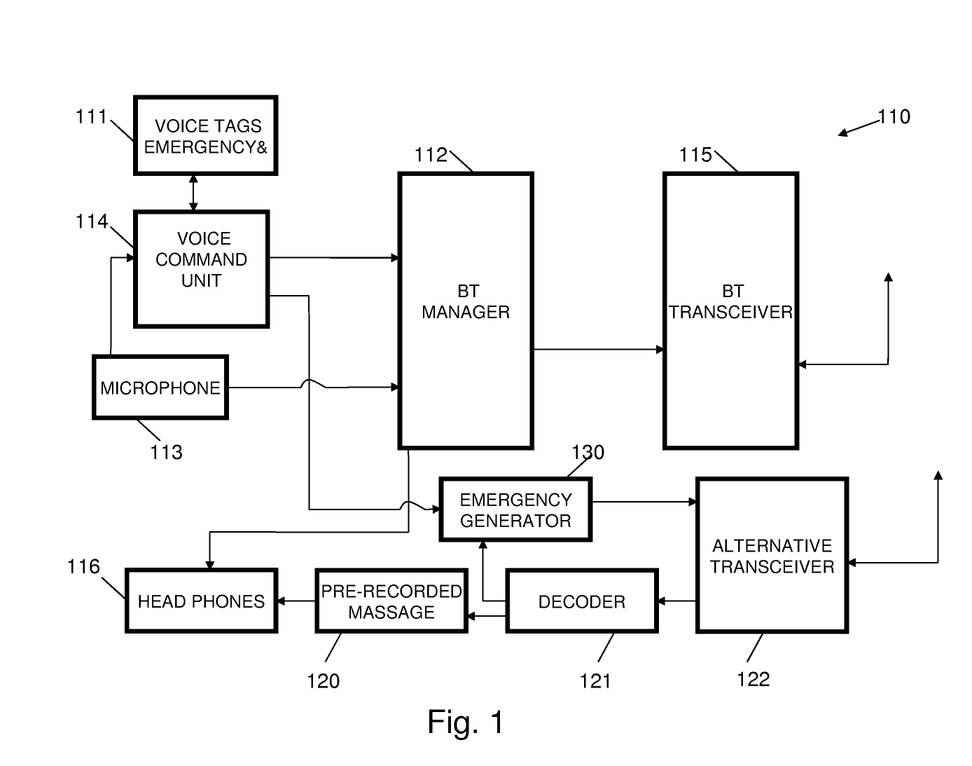

FIG. 1 describes in block diagram form a basic structure of a Bluetooth (BT) device 110 for motorcyclists which is provided with voice commands capabilities, communication between two Bluetooth devices, and with broadcasting of emergency messages. It should be noted that the terms “unit”, “generator”, “manager”, etc. that appear in the drawings do not necessarily require them to be a separate hardware component. In fact they are typically embodied by software. The block diagram description in the drawings is provided in this manner for the sake of simplicity and clarity of understanding. The device comprises storage 111 of voice tags of similar other devices with whom the device can selectively communicate (one to one communication), and the corresponding BT addresses of those devices, and with an additional voice tag assigned for emergency message broadcasting. Before a typical BT communication can be performed, a pairing procedure in a manner known in the art is performed between the device and each other device, enabling the establishment of communication, when necessary, between the device and any selected other device from storage 111. The Bluetooth manager 112 handles all the procedures that relate to the pre-communication (including the pairing procedure), and to the actual communication. These procedures will not be described herein in detail, as they are well known in the art.

When the user provides a voice command into microphone 113 which relates to an addressee device, the voice command unit 114 compares the submitted voice command with the voice tags stored in storage 111, and tries to identify the addressee (target) device. Upon finding a match, the voice command unit submits to the BT manger the address of the target device. Having this target address, the BT manager creates a voice channel between the device and the selected target device, which is performed via transceiver 115. More specifically, upon the establishment of a communication channel between the two Bluetooth devices, the user can use his microphone 113 to convey a voice message to the user of the target device. A response voice signal which is received from the target device is maneuvered by the Bluetooth manager 112 to the device headphones 116.

As mentioned, Bluetooth devices of the prior art for motorcyclists are incapable of broadcasting emergency messages simultaneously to plurality of other devices. the device 110 of the present invention overcomes this drawback.

As noted, the voice tags storage 111 contains voice tags relating to the address of other devices, and an additional, emergency voice tag. Storage 111 may still include additional voice tags for the activation of some other functions that are irrelevant to the invention. The emergency voice tag is typically one or two words that define an emergency situation, for example, “emergency”, or “be careful”, etc.

Therefore, when the user of the device wishes to communicate with a selected another device, he calls to microphone 113 the name of the other device (for example “John Smith”, “Kevin Costner” etc)., and the Bluetooth manager 112 establishes a Bluetooth voice channel with the target device as described above.

However, when the user faces an emergency situation, he speaks to microphone 113 the word or phrase that corresponds to the emergency tag (such as, “emergency”, “be careful” etc.). The voice command unit 114, upon recognition of the emergency tag (by comparison with said pre-stored voice tags), triggers the emergency generator 130, which in turn generates an emergency code for broadcasting. The emergency code is typically a digital word which combines an emergency code field, and a message type field. The message type defines whether the emergency message is originated in this device, or alternatively whether the message is originally created at another device, and received at the present device (in that case, the emergency word is recreated for retransmission, in order to extend the range, in a manner which will be detailed hereinafter). In the case when the message is first initiated in the present device, the message type is defined as type 1. The generated message is then transmitted from alternative transceiver 122 (i.e., a transceiver which is separate from Bluetooth transceiver 115). The target device receives the emergency message via its own alternative transceiver 122, which in turn conveys the message to decoder 121. Decoder 121 inspects said message and identifies that it is an emergency message (from the emergency code field), and it also identifies the message type (from the message type field). The identification of an emergency message by decoder 121 results in the triggering of a pre-recorded alert message 120. The pre-recorded alert message is conveyed to the headphones 116, so the user, upon hearing the pre-recorded message, may react accordingly and avoid the dangerous situation.

The emergency message is received by all the (target) devices that are located within the transmission range of a transmitting device (typically several hundreds of meters). In some cases, it is desired to extend the range of transmission. In that case, any decoder which identifies a type 1 emergency received message re-triggers the emergency generator 130. More specifically, in that case, generator 130 generates a new emergency message, this time a type 2 message (i.e., type 2 in the type field of the emergency word). The generated type 2 message is then broadcasted to all the devices in the range of the said target device. For example, several target devices receive the original type 1 message, and all them immediately recreate and transmit a new type 2 emergency message respectively, and said type 2 message may be received by additional devices that have not received the original type 1 message, as they have been out of range). Such retransmission of the emergency message obviously increases the range of propagation of the emergency message up to doubling the range from the first device which originated the original type 1 message. Each device that which receives a type 2 message, but has not previously received the original type 1 message, triggers his pre-recorded emergency sound message 120, which is conveyed to headphones 116.

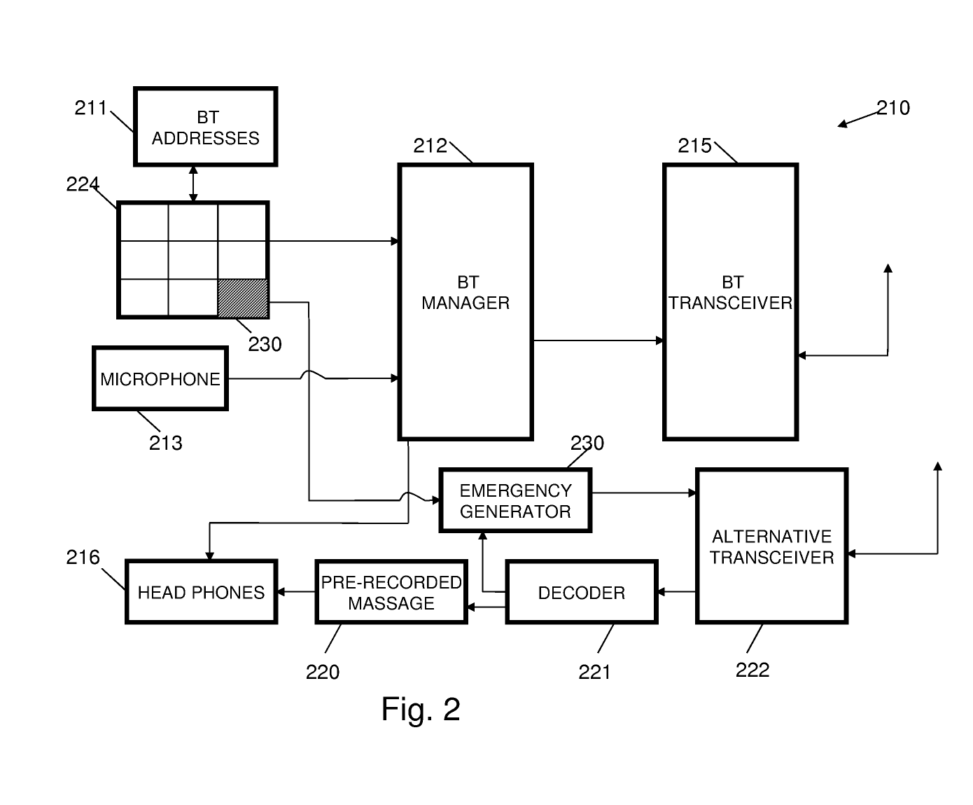

In another embodiment of the invention, the activation of the emergency message in the device may be made by means of pushing a button, rather than by use of a voice command. In that case, the push of the emergency button directly triggers the emergency generator 230. This option may be preferable in devices that do not include voice command capabilities (i.e., voice tags, a voice command unit, etc.). This solution simplifies the structure of the device and reduces its cost. However, this solution requires the user to use his hand to activate an emergency message. FIG. 2 shows an exemplary structure of such an embodiment 210 of the invention. When the user pushes one of the buttons of keyboard 224 that are assigned for Bluetooth communication, the BT manager receives the corresponding BT address from storage 211, and initiates a BT communication in a manner as described before. However, in case of emergency, the user may push the emergency button 230, which directly triggers the emergency generator 230 to issue and broadcast the emergency message in a manner as described above.

The terms “emergency” and “emergency message” should not be connected to any specific situation or type of situation. The user of the device may initiate broadcasting of an “emergency message” in response to any situation that he faces. The pre-recorded message that is provided to the headphones may include any word or combination of words. Moreover, the device may include the option of broadcasting selectively plurality of emergency messages.

As shown, the application provides a mobile device for a group activity that includes the feature of broadcasting of emergency messages to other devices in the group. The device can optionally propagate such an emergency message to target devices that are out of the normal communication range of the device. The operation of the device is convenient and safe, as the emergency message can be generated by means of voice commands. Therefore, the device increases the safety of the users, particularly when used by motorcyclists driving in a group.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A mobile Bluetooth device mounted on a helmet of a user who engages in a group activity, the device comprises a Bluetooth manager for creating a Bluetooth voice communication channel between a source device and a target device via its BT transceiver, and it further comprises an emergency generator for generating an immediate emergency message in a digital form, said emergency message is broadcasted to plurality of target devices via an alternative non-Bluetooth transceiver, such that one of said target devices can receive said immediate emergency message;
wherein each target device further comprises one or more of pre-recorded emergency messages, and wherein each target device, upon receipt of said broadcasted immediate message, sounds a corresponding pre-recorded message to the rider of said target device;
and wherein said immediate emergency messages are intended to alert against immediate obstacles on the way of moving, as observed by the user of the source device.

2. A mobile Bluetooth device according to claim 1, further comprising:
(a) a memory storage which stores target devices voice tags and an emergency voice tag; and
(b) a voice command unit for receiving a user voice command from a microphone, and activating respectively either said a Bluetooth voice communication channel, or said broadcasting of the emergency message, depending on comparison between said voice command and said stored voice tags.

3. A mobile Bluetooth device according to claim 1, wherein said emergency generator is triggered to broadcast an emergency message by means of a push button.

4. A mobile Bluetooth device according to claim 1, wherein said generator generates and broadcasts a type 1 emergency message when said emergency message is first originated in the same device, and generates and broadcasts a type 2 emergency message upon receipt of a type 1 emergency message.

5. A mobile Bluetooth device according to claim 1, which comprises headphones and a pre-recorded emergency message, and wherein upon receipt of an emergency message at a target device, said pre-recorded message is triggered, thereby sounding the message at said headphones.

6. A mobile Bluetooth device according to claim 4, which further comprises headphones and a pre-recorded emergency message, and wherein upon receipt of either a type 1 emergency message or a type 2 emergency message at a target device, whoever comes first, said pre-recorded message is triggered, thereby sounding the message at said headphones.

7. A mobile Bluetooth device according to claim 4, wherein upon receipt of a type 1 emergency message, said emergency generator generates and broadcasts a type 2 emergency message via its alternative transceiver.

8. A mobile Bluetooth device according to claim 1, wherein said user who engages in a group activity is a motorcyclist, a skier, or a bicycle rider.

9. A mobile Bluetooth device according to claim 1, wherein one or more of emergency messages are provided, while the user selects one message at a time for broadcasting.
